(19) United States
(12) Patent Application Publication
(10) Pub. No.: US 2009/0174572 A1
(43) Pub. Date: Jul. 9, 2009

(54) METHOD AND APPARATUS FOR AN ADAPTIVE TARGET VEHICLE NOTIFICATION SYSTEM

(76) Inventor: Alexander E. Smith, McLean, VA (US)

Correspondence Address: ROBERT PLATT BELL;REGISTERED PATENT ATTORNEY, P.O. BOX 13165, Jekyll Island, GA, 31527, US

(21) Appl. No.: 12/340,689

(22) Filed: Dec. 20, 2008

Related U.S. Application Data
(63) Continuation-in-part of application No. 12/233,640, filed on Sep. 19, 2008.
Application No. 12/233,640 is a continuation-in-part of application No. 12/263,517, filed on Nov. 3, 2008.
(60) Provisional application No. 61/043,928, filed on Apr. 10, 2008.
(60) Provisional application No. 61/038,427, filed on Mar. 21, 2008.
(60) Provisional application No. 61/018,897, filed on Jan. 4, 2008.

(51) Int. Cl. G08G 1/00

(52) U.S. Cl. 340/902

(57) ABSTRACT

Methods and apparatus are described to improve emergency vehicle deployment by automatically alerting all other nearby vehicles on the road as to the presence and intention of the emergency vehicle. Since the use of audible sirens has somewhat marked effectiveness, in selecting the most practical automated method to notify most drivers a review is given of the various data-links that are available today, including plans for new standards. The invention focuses on the ubiquitous cellular telephone and methods are described to relay an emergency vehicle's siren through the device to help clear the road ahead for the emergency services vehicle. Furthermore, the method uses techniques to determine which cell users are in the path of the vehicle and targets only those cell devices to relay the siren. The relaying is virtual as it may use siren or similar ring-tones that respond to the emergency notification to the user's cell phone number. The invention makes use of calls, broadcasts, SMS messaging, text messaging, Push to Talk (PTT), e mails, and other means of cell phone communication.

### CROSS-REFERENCE TO RELATED INVENTIONS

The present application claims priority from Provisional U.S. Patent Application Ser. No. 61/043,928, filed on Apr. 10, 2008 and incorporated herein by reference; The present application claims priority from Provisional U.S. Patent Application Ser. No. 61/038,427, filed on Mar. 21, 2008 and incorporated herein by reference; The present application also claims priority from Provisional U.S. Patent Application Ser. No. 61/018,897, filed on Jan. 4, 2008 and incorporated herein by reference; The present application is also a Continuation-In-Part of U.S. patent application Ser. No. 12/233,640, filed on Sep. 19, 2008 and incorporated herein by reference. The present application is also a Continuation-In-Part of U.S. patent application Ser. No. 12/263,517, filed on Nov. 3, 2008 and incorporated herein by reference.

### FIELD OF THE INVENTION

The present invention is directed toward methods and apparatus for improving emergency vehicle deployment by automatically alerting all other nearby vehicles on the road as to the presence and intention of the emergency vehicle.

### BACKGROUND OF THE INVENTION

In a Mar. 14, 2008 letter to the Washington Post, incorporated herein by reference, Lt. Larry Chapman of the DC Fire and Emergency Medical Services Department wrote about the difficulties encountered in getting appropriate driver and vehicle reaction to emergency sirens. He stated that he would like to see the decibel level of audible warning devices reduced on emergency vehicles, but as a former driver in the D.C. Fire and Emergency Medical Services Department he advocates turning them up even louder instead. He described the frustration for emergency services when they are trying to get to someone in need and are blocked by a driver with his or her windows up, music blaring, perhaps a cell phone conversation in progress and what seems to be a complete disconnection from the world. He points out that the evolution of emergency vehicles once used only a bell rung by hand to clear the way. He went on to ask if science will provide an answer, such as a simple visual system that could alert drivers to the approach of an emergency vehicle.

Driver distractions are generally related to loud music, audio from movies or television (assuming the driver is not viewing the video source) and cell phone conversations. Music sources include CD, MP3, and radio including AM, FM, HD, or satellite transmission (XM/Sirius). According to http://en.wikipedia.org/wiki/HD_Radio, incorporated herein by reference, HD Radio is the registered trademark for the in-band on-channel technology selected by the Federal Communications Commission (FCC) in 2002 for terrestrial digital audio broadcasting in the United States. The technology was developed by iBiquity Digital Corporation, and it allows stations to simulcast compressed digital audio and traditional analog audio, without changing to new frequency bands.

The specification for this standard offers two operating modes: “All Digital” and “Hybrid Digital.” According to iBiquity, www.ibiquity.com, incorporated herein by reference, the name “HD Radio” is simply iBiquity's brand for its digital radio technology; however, according to the HD Radio Alliance the HD means Hybrid Digital. As of 2007, more than 1200 AM and FM stations are broadcasting with HD Radio technology, with over 500 FM stations offering more than one digital channel per FM frequency, thus doubling or tripling the number of programs available to listeners. Most of the stations that have adopted the technology are FM, while AM stations have been slower to upgrade. As with traditional AM, FM and TV broadcasting, HD Radio programming is free and supported either by commercial advertising or public broadcasting. As for new digital TV standards, consumers must upgrade to a new receiver in order to receive digital broadcasts.

HD uses Orthogonal Frequency-Division Multiplexing (OFDM), a digital multi-carrier modulation scheme, which uses a large number of closely-spaced orthogonal sub-carriers to carry data. These sub-carriers typically overlap in frequency, but are designed not to interfere with each other as would be the case with traditional frequency division multiplexing and may be efficiently separated using a Fast Fourier Transform (FFT) algorithm. Each sub-carrier is modulated with a conventional modulation scheme maintaining data rates similar to conventional single-carrier modulation schemes in the same bandwidth. OFDM has developed into a popular scheme for wideband digital communication, whether wireless or over land lines, used in applications such as digital television and audio broadcasting, wireless networking and broadband internet access.

HD has a low adoption at this time in the United States compared to conventional analog radio. According to a recent BIA Financial Network report, www.bia.com/HD_Radio_trends_adoption_top_stations.asp, incorporated herein by reference, many of the large groups have already stepped up to HD Radio. Among big groups, the highest number of stations on the air is Clear Channel, with some 375 airing HD Radio, or about a third of its station holdings. Meanwhile, the groups with the highest percentage of multicasts are Emmis, Greater Media and Bonneville, all with a bit more than half of their stations airing multicast channels now. Clear Channel has 274 multicasts, again the most by number of stations. Almost 90% of Bonneville stations (27 of 31 stations) are on the air with HD Radio and Greater Media is at a 70% rollout, with 14 of 19 stations on the air. About 65% of Emmis' 23 stations have converted, and CBS is at 60% of its 140 outlets. Entercom and Radio One are also above the 50% mark.

While this is encouraging from a supply point of view, the user adoption rate is much slower. According to a December 2007 industry report from Chris Roden of Parks Associates, incorporated herein by reference, in four years, satellite radio will have 39 million subscribers, and HD Radio will have 30 million adopters. “The radio space is experiencing a major shift in how audio content is consumed, sold and transmitted to consumers, creating significant growth in the adoption of satellite and HD Radio over the next five years,” he stated, and he sees total satellite users increasing from 20.5 million in 2008 to 39 million by 2012; HD Radio adoption also increasing from 4.2 million to 30 million. “Most satellite radio subscribers use the service in their vehicle. Conversely, HD Radio owners view the product as similar to other consumer electronic devices such as DVD players and home networks and they are more likely to listen to the service at home.” (See FIG. 1).

The two major satellite radio companies continue to invest in their technology, infrastructure, and services. In a Mar. 22, 2008 report on http://satelliteradiotechworld.blogspot.com, incorporated herein by reference, it was stated that Sirius had filed an application to launch and operate a new non geostationary orbit satellite (FM-6). The satellite will replace two existing non-geostationary satellites (FM-1 and FM-2) that are currently in operation. FM-6 would be placed half way between where FM-1 and FM-2 operate today. The launch is expected to take place in 2010, according to the report. Sirius had already been granted authority to launch a geostationary satellite (FM-5) which will significantly alter its existing satellite constellation, resulting the in the eventual constellation of three satellites; two non geostationary satellites (FM-3, FM-6) and one geostationary satellite (FM-5). FM-6 will have twice the transmit power of FM-1 and FM-2. The digital throughput is 1.35 Mbps and the additional capacity will be used to provide more audio channel programming and data; but is currently providing three compressed video channels primarily for vehicle back seat viewing. Each video is compressed to approximately 255 kbps. Presently, music is compressed to 44 kbps; voice, 20 kbps; and 16 kbps for low quality audio such as traffic and weather, implying a spare capacity of 585 kbps, enough for 13 more music channels.

According to Professor Kelly Rainer from Auburn University, www.auburn.edu/˜rainerk/telematics.html, incorporated herein by reference, telematics systems are seen as a major source of new revenue for automobile manufacturers. Telematics proponents view the car as a platform through which to sell not only wireless safety and security services—keyless remote access or stolen vehicle tracking—but through which they will gain revenue from drivers downloading e-mail, stock quotes, voice-activated concierge services from the Internet, and usage-based insurance (the perfect insurance savings plan for Sunday drivers).

Telematics is projected to be a $13 billion a year industry in the United States by 2010. Worldwide, telematics is predicted to grow to a $41 billion market by 2010, as Japanese and Western European consumers try to battle gridlock with real-time traffic report and navigation applications. According to the General Motors website for OnStar, www.onstar.com/us_english/jsp/explore/onstar_basics/technology.jsp, incorporated herein by reference, there are over two million subscribers as of March 2008, and OnStar is the leading provider of telematics services in the United States. OnStar's in-vehicle safety, security, and information services use GPS and cellular technology to link the vehicle and driver to the OnStar center.

Newer, more flexible, vehicle data-link systems are on the horizon. In a presentation to Capital Science 2008 Conference, Arlington, Va., 29 Mar. 2009, titled “Security for Wireless Access in Vehicular Environments (WAVE), the Emerging IEEE 1609.2 Standard,” incorporated herein by reference, Tim Weil described a large ongoing system integration program aimed at bringing new standards for vehicle data transfer. The program involves many participants from local and federal government and private industry. The program envisions a future in which intelligent vehicles routinely communicate with each other and the transportation infrastructure in real time. A newly published set of IEEE standards, based on IEEE 1609 Wireless Access for Vehicular Environments (WAVE), incorporated herein by reference, defines architecture and a complementary set of services for secure vehicle-to-vehicle and vehicle-to-infrastructure wireless communication. The IEEE 1609 standards are designed to provide the foundation for a broad range of applications in the transportation environment, including vehicle safety, public safety, communication fleet management, automated tolling, enhanced navigation, and traffic management.

WAVE technology (also called Dedicated Short Range Communications or DSRC) is a short-to-medium-range radio link and operates at 5.9 GHz as authorized by the U.S. Federal Communication Commission (FCC) for intelligent transportation systems. According to Mark IV technologies (http://www.ivhs.com/), incorporated herein by reference, their version of the WAVE product is called “OTTO on Board” uses digital radio technology to pass information over distances of up to 1000 meters between fixed roadside infrastructure and the onboard OTTO device. Built on popular Wi-Fi standards using IEEE 802.11p, WAVE operates in a spectrum of 75 MHz at 5.9 GHz, reserved by the FCC specifically for high priority highway safety messages which may also be used for private applications. In addition to giving drivers information to help them reach their destinations safely and efficiently, WAVE radio will open a range of transportation applications, such as Internet access, arranging for lodging, and ordering goods and services in transit. IEEE 1609 standards include:
IEEE 1609.1, “Trial-Use Standard for Wireless Access in Vehicular Environments (WAVE)—Resource Manager,” which describes the flow of the command-response interchange between multiple remote applications and the resource manager.
IEEE 1609.2, “Trial-Use Standard for Wireless Access in Vehicular Environments—Security Services for Applications and Management Messages,” which covers methods to make WAVE messages secure against eavesdropping, spoofing and other attacks. IEEE 1609.3, “Trial-Use Standard for Wireless Access in Vehicular Environments (WAVE)—Networking Services.”
IEEE 1609.3 is part of a standards family to support vehicle-to-vehicle and vehicle-to-roadside communications that will allow motor vehicles to interact with each other and roadside systems to access safety and travel-related information. It defines services at the network and transport layers to support this wireless connectivity.

IEEE 1609.4, “Trial Use Standard for Wireless Access in Vehicular Environments (WAVE)—Multi-channel Operation,” which provides an interface to the medium access control of the communication stack and provides for multi-channel operation versus the single channel of IEEE 802.11p.

A fifth standard is underway as an architecture document that will give an overview of WAVE systems and their components and operation, as well as a context to better understand the content of other WAVE standards and IEEE 802.11 (WAVE mode). In assessing these and other new standards, it is important to recall how long it takes for a refresh of vehicles on the roads, as the average age of a car is now over 9 years and increasing, as shown in FIG. 2, from the R.L. Polk Co., at http://www.polk.com/, and incorporated herein by reference. Therefore any technologies or systems that rely on new integrated systems will not see full benefits for 15-20 years from now. The average number of vehicles owned per household is also on the rise, shown in FIG. 3, taken from U.S. DOT statistics, listed in the 2006 Transportation Statistics Annual Report, Research and Innovative Technology Administration, Bureau of Transportation Statistics, and incorporated herein by reference. That report shows that the number of cars owned per U.S. household has increased by over 60% between 1969 and 2001.

Other on-board vehicle sensors include forward-looking radar as well as rear facing collision sensors. A good technical description of Automatic Cruise Control (ACC) radar for vehicles is provided in the 2001 IEEE paper, “A Compact Manufacturable 76-77-GHz Radar Module for Commercial ACC Applications” by Gresham et al., incorporated herein by reference. While those devices are coming more commonplace in new vehicles there is no readily available market information on their adoption rates, although generally it is thought that many newer cars will have them available in an integrated fashion. A summary of the various onboard systems and the types of data-links available to vehicles discussed above is summarized in FIG. 4. In summary, while there are many different ways to broadcast or message the driver of a vehicle the overall all adoption rate of any one system is low; i.e., some users have HD radio, some have conventional radio, others have satellite radio, but there is no practical way to tap into or effectively use these existing systems in a small region that would communication with a meaningful number of vehicles.

The U.S. Department of Transportation, Research and Innovative Technology Administration, Bureau of Transportation Statistics, Transportation Statistics Annual Report (Washington, D.C.: 2006), incorporated herein by reference, gives the number of vehicles on the road by type. Also based on the other information presented it allows the estimation of overall vehicle occupancy, which is 1.59 people per vehicle (excluding busses and public transport). As shown in FIG. 5, this is a gross median value per vehicle and may have no useful statistical meaning, but it does show, not surprisingly, that there is generally more than one person in each vehicle.

All of this data illustrates that various new communications links are being implemented or are contemplated, which may allow for enhanced communication between vehicles and vehicles and ground stations in order to transmit data to vehicles. Such communications links may provide the technological answer that Lt. Larry Chapman was looking for—a way to alert drivers of the presence of an emergency vehicle, even while they are being distracted by in-car entertainment and the like. A number of patents or Published patent applications already describe such scenarios.

Jacobs, Published U.S. Patent Application No. 2007/0273551, published Nov. 29, 2007, and incorporated herein by reference, discloses an advanced warning system for emergency vehicles. This reference requires that a certain “module” be installed in the user's vehicle, and only flashes yellow or red lights of an emergency vehicle is within a certain radius of the car. One problem with the Jacobs device, is that it requires specialized hardware be installed in consumer vehicles. There is little or no financial incentive for consumer to install these “Interface Modules” at their own expense, and thus, unless the system were incorporated into new vehicles or vehicle accessory hardware, implementation would be difficult. Even if such installation were mandated for newer vehicles or the like, it would be years before such hardware would propagate through the population to make much of an impact in terms of improved safety. It would be preferable if a system could be implemented immediately, using existing technology and hardware that most consumers already have, either in their car or on their person.

Vassilevsky, Published U.S. Patent Application No. 2005/0035878, published Feb. 17, 2005, and incorporated herein by reference, discloses an early warning system for approaching emergency vehicles. Stationary or portable units may receive radio signals to alert users of emergency vehicles. While Vassilevsky attempts to solve the problem stated by Lt. Larry Chapman—namely warning citizens of the approach of an emergency vehicle, Vassilevsky suffers from the same problems as Jacobs, in that his system requires an investment in infrastructure to install stationary “warning devices” on each street corner, or the sale of such portable devices to consumers (or incorporation of such devices into existing consumer electronics). Vassilevsky uses directional radio signals to determine which devices should be activated. His device does not discriminate between portable devices which a consumer might have in his vehicle, or in a nearby office building, which may lead to false alarms for consumers not in the path of the emergency vehicle.

Himmelstein, U.S. Pat. No. 6,647,270, issued Nov. 11, 2003, and incorporated herein by reference, discloses VEHICLETALK, which allows a vehicle to communicate with neighboring vehicles and also roadside communications networks. This reference is an illustrative example of one embodiment of the vehicle communications technologies currently envisioned or under development and known in the art.

FIG. 6, from the encyclopedia of earth, www.eoearth.org/article/Cell_phone_recycling, incorporated herein by reference, shows the constant rise in U.S. cell phone service subscriptions, with over 180 million subscribing by 2004. Globally, as reported by Joel Garreau in the Washington Post on Feb. 24, 2008, we have now passed a milestone of more than 3.3 Billion active cell phones on a planet of some 6.5 billion humans in a period of about 26 years. This is the fastest global diffusion of any technology in human history, according to Garreau. Industry experts predict another billion users by 2010 and the final billion or so with a few years thereafter. It is certainly the case that most U.S. adults carry an active cell phone, or those driving and riding in vehicles. Coupled with the research noted above, it is reasonable to assume that there is generally more than one, or at generally least one active cell phone in a vehicle on the road.

Cell phones, therefore, represent a technology, which has already been widely implemented in most developed countries (and even in many developing countries). Nearly everyone has a cell phone, it seems. Moreover, the life-cycle of a cell phone is far shorter than that of an automobile. Automobiles generally have a design life of 10-15 years, and thus new technology offered in automobiles may take a decade or more to work its way through the inventory of existing vehicles. Cell phones, in contrast, are often discarded after only a few years of use, and new technology can be more readily implemented and distributed in that hardware base.

Thus, it would appear that cell phone technology would be a better approach to implementing a vehicle warning system, as it would not require modifying automobiles to implement such a technology. Moreover, such warnings could be received by pedestrians and bystanders, as well as drivers, enhancing the safety of pedestrians as well. Cell phones could be designed to receive emergency vehicle warning signals and then communicate these warnings to cell phone users.

McKenna, Published U.S. Patent Application No. 2007/0046499, published Mar. 1, 2007, and incorporated herein by reference, discloses a number of embodiments for alerting vehicles of the presence of emergency vehicles in the area, including embodiments mounted in a rear-view mirror, center high mounted stop light, and license plate frame. One embodiment of interest discusses using a cell phone, and mentions that emergency information may be displayed or communicated through “a speaker” on the cell phone.

The method of communication disclosed in McKenna appears to encompass a variety of means, including optical or a specialized emergency frequency, both of which would require the use of a specialized cell phone and thus resist rapid adoption. McKenna does not disclose any means of discriminating between vehicles on the road and bystanders or others not of interest.

Gill, Published U.S. Patent Application No. 2008/0074286, published Mar. 27, 2008, and incorporated herein by reference, discloses an emergency vehicle alert system. An emergency vehicle alert system provides alerts to a client application that an emergency vehicle is on approach. The emergency vehicle alert system includes a transmitting device installed in an emergency vehicle and a receiving device installed in a client application. The transmitting device of the emergency vehicle triggers a response in the receiving device of the client application when the emergency vehicle is within a predetermined radius of the client application. The client application may be an automobile, portable music player, car stereo, GPS navigation system and/or a cellular telephone.

In paragraph [0019] of this application, Gill recites: “In other embodiments, SMS messages may be utilized to deliver a message to a cell phone user that an emergency vehicle is within the vicinity. When an SMS message is received by a cell phone, the normal response on the cell phone is a sound, vibration, or both to notify the user of the message. In these embodiments, the emergency vehicles would utilize a cellular phone's network to delivery emergency activity information to any and all cellular phones located within the vicinity. This system would cover all situations with cellular phone users, not just those using their cellular phones in their vehicles. Pedestrians and/or people in the surrounding areas on their cellular phones would also receive the SMS messages.”

Thus, while Gill discloses the generic idea of sending a message to a user via cell phone, It does not appear that the user will be able to distinguish such messages from other SMS (Short Message Service, or text messaging) messages, unless they read the actual message. As a result, a user receiving an SMS message of Gill would not realize it is an emergency vehicle notification. Moreover, as using cell phones (and certainly text messaging) is illegal in many states, a user driving a car could not safely retrieve the message and determine that an emergency vehicle is nearby. In fact, one could argue that the Gill device, as applied to a cell phone in an automobile, would make the user more likely to get into an accident with the emergency vehicle, if the user attempts to receive an SMS message at the very moment they should be situationally aware.

Gill also mentions broadly the idea of transmitting emergency signals to vehicles within a certain radius (paragraph [0013]). However, Gill does not teach or suggest a definite technique for determining whether a particular vehicle is within a certain radius. For RF applications, this could be easily implemented by a transmitter of a certain power level that transmits in all directions a certain distance. But for a cell phone application, a different approach would be required. Gill only cryptically recites that “In these embodiments, the emergency vehicles would utilize a cellular phone's network to delivery emergency activity information to any and all cellular phones located within the vicinity.” Such a technique, without knowing the location of users on the roadway, would tend to generate a lot of false alarms—people in nearby buildings in large cities would be receiving alarms all day long, which might prompt them to shut off their phones or disable the alarm generating service.

Discriminating between drivers and pedestrians in the path of an emergency vehicle and others who are not in the path of an emergency vehicle is one key to successful implementation of an emergency vehicle warning system. False alarms in any system can lead to users discounting or disconnecting the technology, which defeats implementation of the technology. For example, if a smoke detector goes off too often and erroneously, a user may disconnect such a smoke detector to stop such nuisance alarms, which defeats the entire purpose of the alarm. If a real fire were to occur, the user would not be warned. Similarly, car alarms go off so often and erroneously that most urban dwellers view them as a nuisance. Few, if any, pay attention to car alarms, and as a result, the effectiveness of car alarms in deterring theft is reduced. Burglar alarms have the same problem. If they go off erroneously too often, users may decide not to set the alarm, and the effectiveness of such an alarm is lost. Thus, in order to be effective, any alarm system has to discriminate between real and false alarms and keep the number of false alarms to a minimum

For a cell phone enabled emergency vehicle alarm, false alarms must be kept to an absolute minimum, otherwise users would disable the feature from their cell phone. In large cities and urban areas, a large number of emergency vehicles travel through a given block or intersection every day. High density office buildings may house thousands of workers, each with a cell phone. It would be a severe inconvenience and annoyance if these users are alerted every time an ambulance or fire truck drives down the adjacent street. As a result, such users would shut off or disable such emergency notification service (or shut off their cell phones) to prevent receiving such false alarms. If they failed to remember to reactivate the device when returning to the street, the effectiveness of the warning system is lost.

Drivers on adjacent streets may find such spurious warnings inconvenient or even dangerous. If an ambulance is traveling down a main street, and a driver on an adjacent street receives a warning, he may panic, looking for the ambulance (which isn't there) and thus be distracted from his driving. Moreover, if a driver receives a number of such “false alarms” he may be condition to ignore such alarms, or may turn off or disable the alarm feature on the device. Thus, for such an electronic warning system to be effective, it is important that only those persons near the path of the emergency vehicle be notified, and those persons who are in nearby buildings or adjacent streets (out of the path of the emergency vehicles) not be notified.

For tracking accuracy of cell phones, Wikipedia has a good article that covers many of the technologies, at http://en.wikipedia.org/wiki/GSM_localization and incorporated herein by reference. The article describes Localization-Based Systems (LBS) as network based, handset based, or hybrid. The handset based unit calculates its own position and the other techniques using various other methods to pinpoint the cell phone. The article then goes on to classify the accuracy of each technique as follows:
Cell Identification—the accuracy of this method can be as good as a few hundred meters in urban areas. Enhanced Cell Identification—this method has precision similar to Cell Identification.
TDOA—Time difference of arrival—the network determines the time difference and therefore the distance from each base station to the mobile phone.
TOA—Time of arrival—essentially similar to TDOA, but this technology uses the absolute time of arrival at a certain base station rather than the difference between two stations.
AOA—Angle of arrival—which locates the mobile phone at the point where the lines along the angles from each base station intersect.
E-OTD—similar to TDOA, but the position is estimated by the mobile phone, not by the base station. The precision of this method may vary from 50 to 200 m.
Assisted-GPS—uses an operator-maintained ground station to correct for GPS atmospheric errors. This accuracy can be as good as just a few meters.

What the article does not describe, however, is the growing use of cell phone GPS with in-built GIS databases—for example, that available in the Blackberry Curve. These units potentially provide far better positioning accuracy as they combine the satellite navigation with the smoothed tracking and the road network database, much as is found in today's onboard automobile systems. These newer popular phones offer the ability to determine location very precisely. Thus, it is possible to readily determine the location of a cell phone using one or more known tracking techniques.

Rosenberg, Published U.S. Patent Application No. 2007/0159354, published Jul. 12, 2007, and incorporated herein by reference, discloses an intelligent emergency vehicle alert system. Rosenberg apparently recognizes the importance of distinguishing between vehicles of interest and other vehicles, as he uses “locative data” to determine which vehicles should be warned. Rosenberg recites, in Paragraph [0025]: “More specifically, embodiments of the present invention provide an intelligent emergency vehicle alert system that informs a driver of a ground vehicle of the presence of a responding emergency vehicle (“REV”) by considering the relative location of the emergency vehicle with respect to the ground vehicle as well as considering one or more additional factors such as the road of travel, the direction of travel, a forward/aft comparison, and a road size determination. In this way the driver of the ground vehicle may be selectively alerted to the presence of an REV if that ground vehicle needs to take evasive action to allow the REV to pass, but may not be alerted to the presence of a responding emergency vehicle if no evasive action is required.”

Rosenberg further describes his on-board device used by Rosenberg is described in paragraphs [0028-9] as follows: “Embodiments of the present invention perform the above determinations by using a plurality of computing devices that are in networked communication and thereby operate in combination. The plurality of computing devices includes a local computing device that is located on board each ground vehicle for which the present invention is enabled.” “As used herein, “local computing device” should be broadly construed as including any mobile wireless client device that is associated with a vehicle and moves with that vehicle. A typical local computing device is a wireless access protocol (“WAP”)-enabled device that is capable of sending and receiving data in a wireless manner using the wireless application protocol. The WAP may support wireless networks, including Cellular Digital Packet Data (“CDPD”), Code Division Multiple Access (“CDMA”), Global System for Mobile Communications (“GSM”), Personal Digital Cellular (“PDC”), Personal Handy-phone System (“PHS”), Time Division Multiple Access (“TDMA”), FLEX, ReFLEX, Integrated Digital Enhanced Network (“iDEN”), Terrestrial Trunked Radio (“TETRA”), Digital Enhanced Cordless Telecommunications (“DECT”), DataTAC, and Mobitex, and it operates with many operating systems.”

It appears that Rosenberg requires the use of a specialized device in his vehicles that only may use cellular frequencies, not a cellular device per se. Thus, Rosenberg requires that vehicles be modified or manufactured to incorporate such a device, which includes a GPS tracking system and a magnetometer to determine direction of travel. Rosenberg also requires the use of a GPS system in the vehicle. While some cell phones may be equipped with GPS receivers, they represent a minority of cell phones in use. Moreover, a cell phone in a vehicle may not be able to obtain a GPS signal without a clear line-of-sight to overhead satellites.

Using mobile phones to send alerts in some form of broadcast are used for other applications. The Orlando Sentinel, on Apr. 26, 2007, incorporated herein by reference, described an emergency warning system for storm alerts. The paper reported that Seminole County residents could be wearing the equivalent of tornado-warning sirens on their hips during the hurricane season, and that services were expected to provide alerts for tornado watches and warnings by e-mail and on electronic devices such as cell phones, pagers and PDAs. This type of system is a broad county-by-county solution and not necessarily real time. Other systems for mass alerting are now being used at Universities after various major incidents over the past few years. For example there is an emergency warning cell phone test messaging system in place at Tennessee Tech University, described on the University's website, www.tntech.edu/ehs/student_cell_instr.html, and incorporated herein by reference. Also Amber alerts, as described in www.vaamberalert.com/, incorporated herein by reference, use cell phone SMS broadcasting. SMS broadcasting services are available through third party companies, such as EGYPTsms.com as described in www.egyptsms.com/SMS_Broadcasting.htm, incorporated herein by reference.

In view of these Prior Art references, it would appear that iIn order to make Lt. Larry Chapman's dream of an electronic means of communicating emergency vehicle signals to distracted drivers a reality, a number of criteria must be met. First, the hardware should be something that already is in existence and in popular use, and not some specialized add-on module that needs to be purchased, installed, or built-in to existing technology. Second, the system should have an effective means for discriminating between persons in the area who need to be warned, and those who need not be warned, in order to reduce or eliminate the false alarm problem. Third, the system should operate in a transparent manner, such that the user need to answer a text message, phone call, or take other positive action in order to receive the initial alarm. Preferably, the system should be implemented in a manner that a user need take no action at all to even enable such alarm messages.

### SUMMARY OF THE INVENTION

The present invention makes use of personal mobile devices to communicate between emergency vehicles and persons on or near a roadway. Methods and apparatus are described to improve emergency vehicle deployment by automatically alerting all other nearby vehicles on the road as to the presence and intention of the emergency vehicle. Since the use of audible sirens has somewhat marked effectiveness, in selecting the most practical automated method to notify most drivers a review is given of the various data-links that are available today, including plans for new standards. Research concludes that use of today's newer vehicle data-links is currently ineffective due to the fragmentation and, in many cases, low adoption rates, including satellite radio, HD and conventional radio, automatic cruise control radar, and vehicle telematics (e.g., General Motors' OnStar).

Basically none of the newer digital data-links in use today are each capable of reaching more than a few percent of all users on the road, so a notification system that relies on breaking through or working on these channels will have very limited effectiveness, practical implementation issues aside. The new IEEE vehicle data-link standards offer the potential, but, based on the research, any reasonable amount of adoption is 15 years or more into the future. Therefore, the invention focuses on the ubiquitous cellular telephone and methods are described to relay an emergency vehicle's siren through the device to help clear the road ahead for the emergency services vehicle.

Furthermore, the method uses techniques to determine which cell users are in the path of the vehicle and targets only those cell devices to relay the siren. The relaying is virtual as it may use siren or similar ring-tones that respond to the emergency notification to the user's cell phone number. The invention makes use of calls, broadcasts, SMS messaging, text messaging, Push to Talk (PTT), e mails, and other means of cell phone communication.

In one embodiment of the present invention, cell phone positions are tracked using multilateration (Time Difference of Arrival) or other passive techniques, such that mobile phones with and without GIS capabilities can be located accurately. An algorithm is used to determine which cell phones are in an area of interest—in the path of an emergency vehicle or potential path of an emergency vehicle. Users in nearby buildings or adjacent streets may thus be filtered out and false alarms prevented. Next, an alarm ring tone may be generated on the cell phones of those users who are determined to be in the path or potential path of the emergency vehicle. A unique ring tone (e.g., siren ring tone) or even a voice message (e.g., “Emergency Vehicle Approaching”) may be generated, without the need for the user to answer the phone or read a text message or the like. The system may be implemented without the need for users to buy new vehicles, modules, cell phones, or other equipment, and thus can be widely adopted in a short period of time.

### BRIEF DESCRIPTION OF THE DRAWINGS

FIG. 1 is an extract from the December 2007 Industry Report by Chris Roden of Parks Associates showing satellite radio and HD radio ownership in the United States.

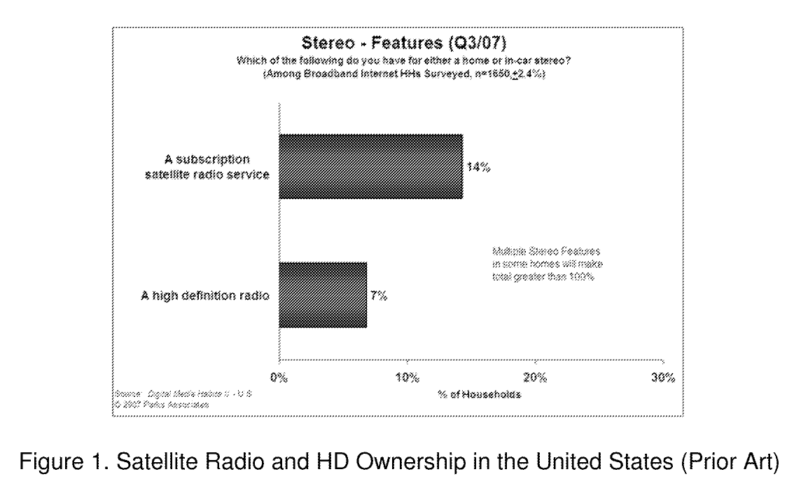

FIG. 2 shows the average age of an automobile in the United States and is extracted from the R.L. Polk Co., at www.polk.com

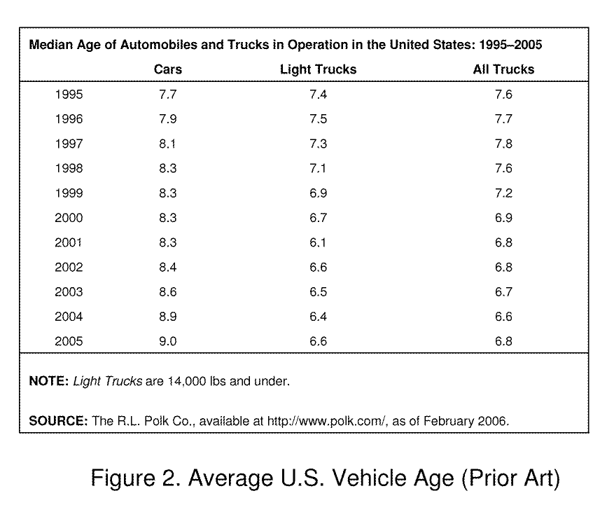

FIG. 3 is an extract from U.S. DOT statistics, listed in the 2006 Transportation Statistics Annual Report, Research and Innovative Technology Administration, Bureau of Transportation Statistics showing the number of cars owned per U.S. household has increased by over 60% between 1969 and 2001.

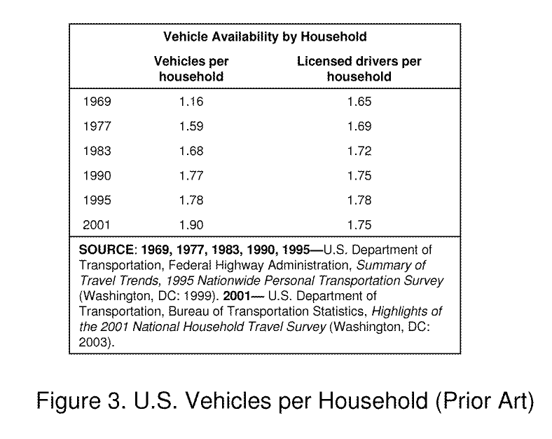

FIG. 4 is a summary of the various data services on today's automobiles showing equipage estimates where the information is available, including telematics, radio services, and on board sensors.

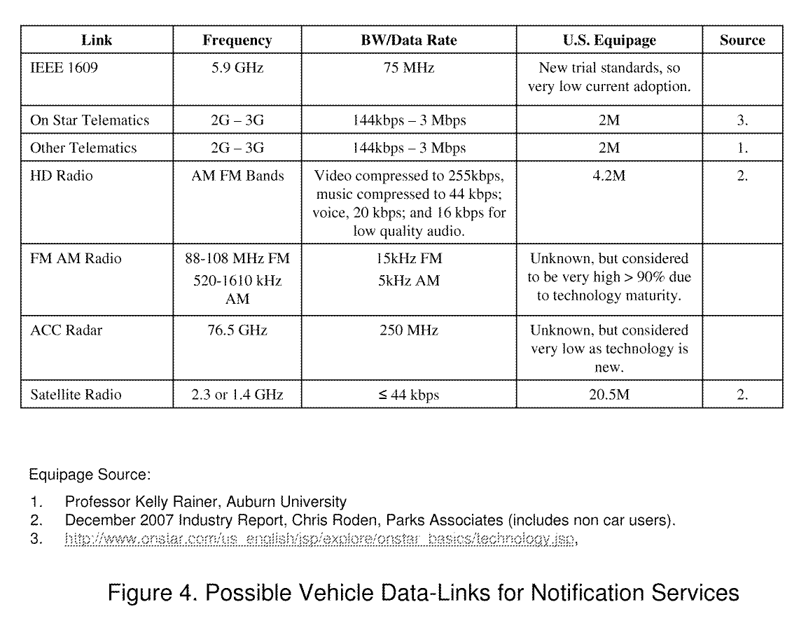

FIG. 5 shows a derivation of vehicle occupancy based on information from the U.S. Department of Transportation, Research and Innovative Technology Administration, Bureau of Transportation Statistics, Transportation Statistics Annual Report (Washington, D.C.: 2006).

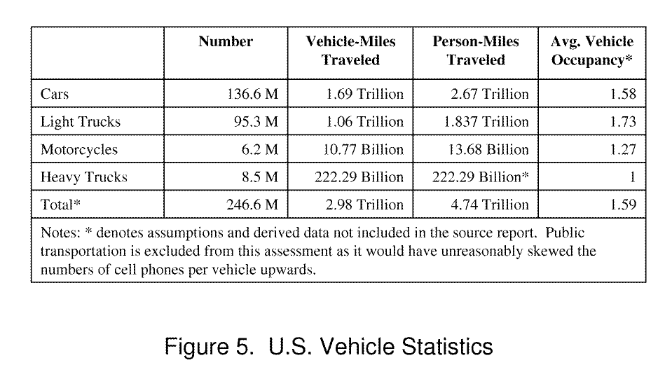

FIG. 6 is extracted from the Encyclopedia of Earth, www.eoearth.org/article/Cell_phone_recycling, shows the constant rise in U.S. cell phone service subscriptions, with over 180 million subscribing by 2004.

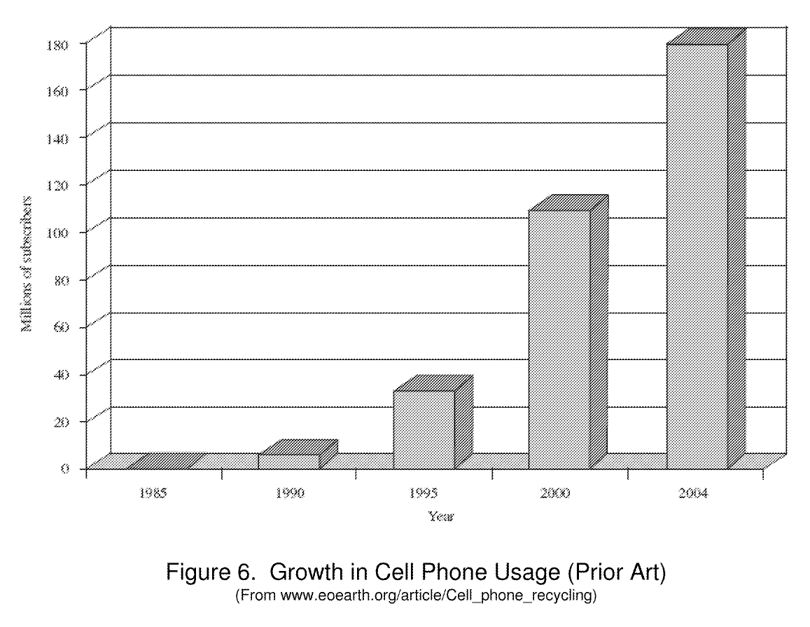

FIG. 7 is the first embodiment of the invention, showing the use of dynamic zones to locate mobile phone users.

FIG. 8 is the second embodiment of the invention, showing the use of known emergency vehicle routing information.

FIG. 9 is a flowchart of the third embodiment of the invention, showing how users are identified as intervening and then notified.

FIG. 10 is a flowchart of the fourth embodiment of the invention, showing how the system can optionally use emergency vehicle routing information.

### DETAILED DESCRIPTION OF THE INVENTION

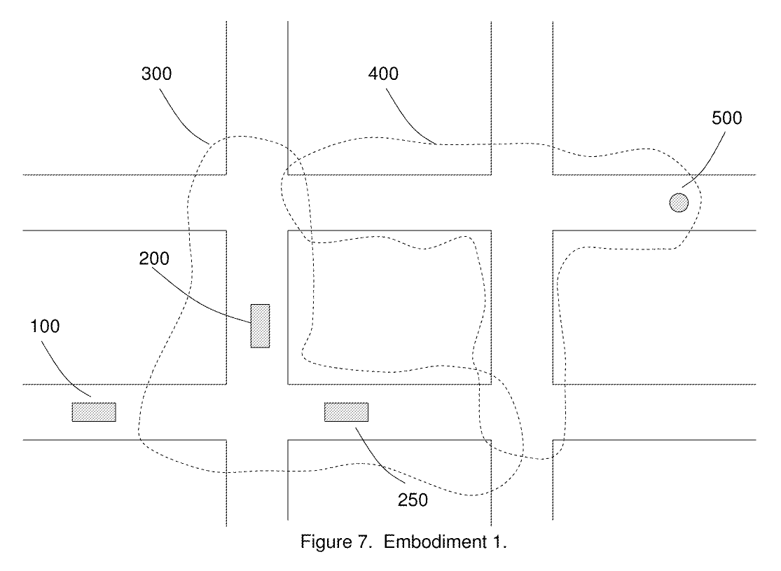

FIG. 7 shows a first embodiment of the invention with an emergency response emergency response vehicle 100 traveling to a reported incident 500. The position of emergency response vehicle 100 may be known using any one of a number of vehicle tracking techniques, including GPS, multilateration, and the like. Position of emergency response vehicle 100 may then be reported via cellular or RF link to a processing center. The processing center may comprise an off-site processing center run independently of fire and emergency services, (e.g., by contractor) or may be integrated into a cellular network, or may be part of a system marketed and sold to fire and emergency services providers (municipalities and the like). Alternately, computation of position and transmission of warnings to motorists and bystanders may be performed using equipment onboard emergency response vehicle 100.

In the scenario of FIG. 7, it is unknown as to whether the driver of emergency response vehicle 100 will take a left turn and go north 200 or continue in a straight motion 250. Therefore, as the emergency response vehicle 100 approaches the first intersection, two zones are established 300 and 400. The two zones are for the first wave of siren forwarding 300 and the second wave of siren forwarding 400. This scenario is when the intended route of the emergency response vehicle 100 is not known, which is not always the case, as the route may be part of a satellite navigation GIS route or a dispatch preferred route. Once the emergency response vehicle 100 proceeds beyond the first intersection 200, 250, the second zone 400 may be automatically modified so as not to alert non-intervening vehicles or cell users.

Alerts may be transmitted to local cellular phones or other messaging devices in a number of ways. A tone or alarm may be sounded on a communications device, to alert the user that an emergency vehicle is nearby. In one embodiment, a simple cellular call may be made to users along the route, activating a siren ring tone, to alert the user that an emergency vehicle is nearby. A specialized ring tone (e.g., siren ring tone) may be used to distinguish such calls from ordinary cell phone calls. If the user picks up the call, a recorded or synthesized voice message may report the location of the emergency vehicle along with a warning to be alert for the vehicle and to clear a path for the vehicle. Text data may also be displayed on the communications device (e.g., cell phone) to accompany the alarm signal.

If the users communication device is linked to the vehicle (e.g., Bluetooth™ interface or the like), the alarm or tone may be sounded through the vehicle's audio system. The alarm or tone may comprise a verbal alarm (e.g., “emergency vehicle nearby”), which may play in the background, or may interrupt or mute background music or a cellular phone call, if one is in progress. Alternately, a siren sound or other tone may be played as part of the voice message. If the cellular phone is connected to the vehicle via a Bluetooth™ interface or the like, the alarm may be displayed visually on a vehicle display (e.g., navigation system or the like) as a text message and/or icon. Thus, for example, the position and route of the emergency vehicle may be displayed to a user (e.g., in flashing red), to allow the user to take appropriate measures to avoid the emergency vehicle.

The system determines the location of cellular phones using one of a number of known tracking devices, such as GPS, multilateration, or the like. Thus, the system may determine which cell phones or communications devices are within the vicinity of an emergency vehicle path 300 or 400 and then send alarm messages to such devices. Alternately, the system may simply receive the alarm signal from the emergency vehicle at a particular cell tower or node, and then re-transmit this alarm signal to all communications devices in communication with that cell tower or node. This latte technique may not be as discriminating, as previously noted, but may be easier and less expensive to implement.

Filtering techniques may be used to prevent adjacent users in nearby buildings from receiving spurious alarms. For example, if an office building or the like is located near the route 300 or 400 of the emergency vehicle, it would be undesirable if cellular phone users in the building were notified of emergency vehicle traffic, as such alarms would be intrusive and of no practical use to someone sitting at a desk or at home. In some larger cities, such reports would result in a constant stream of emergency notifications for office workers and others who work or reside near busy streets. Using tracking data or the like, the position of a cellular phone user can be readily determined. If the phone is not in motion for a predetermined period of time, it may be assumed that the user, while near the roadway, is not in a vehicle or a pedestrian. Alternately, users may be able to manually defeat such alarms, however, such a feature may partially defeat the spirit of the present invention.

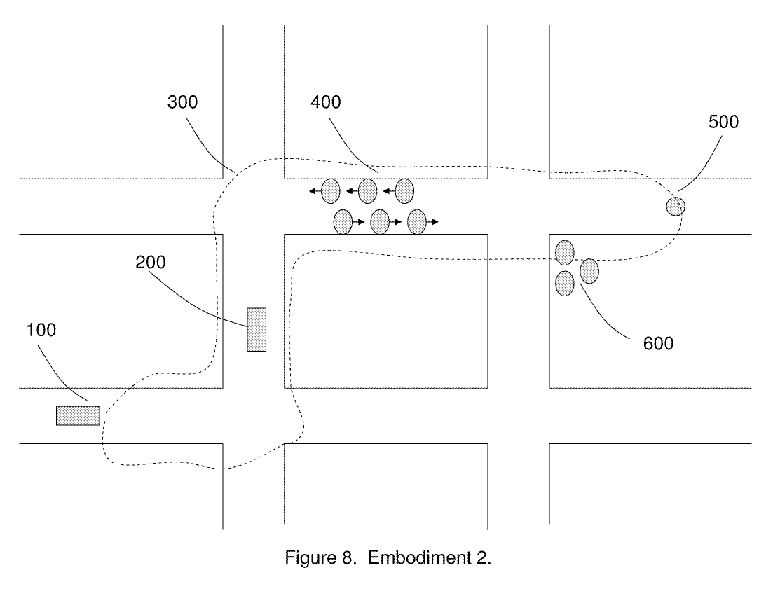

In a second embodiment of the invention, shown in FIG. 8, the route of the emergency response vehicle 100, 200 is either estimated or known and the zone between the emergency services and the incident 500 has been determined 300. As the emergency services vehicle proceeds along the route, calls are made to intervening users/vehicles 400, triggering siren ring-tones alerting them to the approach of an emergency services vehicle. Based on a-priori information and general location of the users 400 it is determined they are vehicles and must be notified. Other cell phone users 600, based on their a-priori information may be determined not to be possible intervening vehicles, for example they may be office workers in adjacent buildings or high above in office buildings. Therefore, calls or notifications will not be made to those cell phones. A-priori information includes 3-D position (i.e., including height) and the velocity of a track of the cell phone over a short period of time.

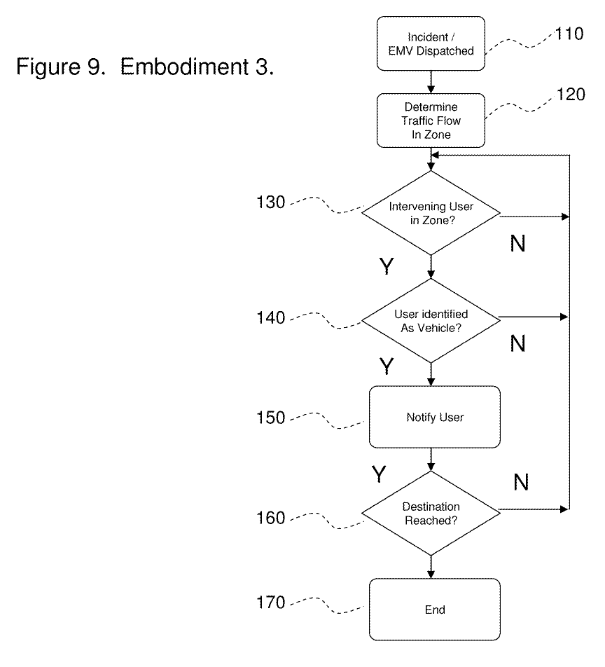

In a third embodiment of the invention, shown in the flowchart in FIG. 9, once an incident is reported, the emergency vehicle is dispatched 110. Traffic flows in the intervening zones are determined, using average velocity and dwell time of users 120. If there is an intervening user or users in the zone of interest, 130, the user is determined to be a vehicle or not based on velocity, a priori information, height, and other information, 140. The user is then notified by sending a message such as an SMS, call, or PTT, to cause the siren or similar ring-tone on the mobile device to activate, 150. The system will continue to notify users until the destination of the emergency vehicle is reached 160, 170. Notification of users in step 150 may be staggered such that alarms are not sent to vehicles until the emergency equipment is within a predetermined distance of the user.

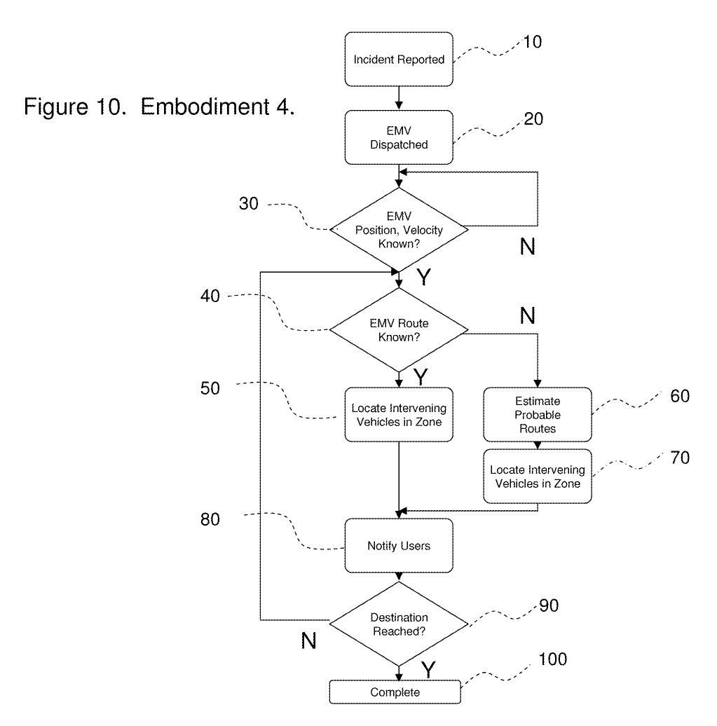

In a fourth embodiment of the invention, shown in FIG. 10, when an incident is reported, 10, an emergency vehicle is dispatched 20. The emergency vehicle is tracked by various means, 30. If the route of the emergency vehicle, 40, is known either from the driver, dispatch, or on-board navigation and routing system, then vehicles in the zone ahead are notified 50, 80. If the route of the emergency is not known, then probable routes are estimated based on a-priori and other information 60. Vehicles estimated to be in the possible zones ahead of the emergency vehicle are notified 70, 80, and notifications cease once the destination is reached 90, 100.

While the preferred embodiment and various alternative embodiments of the invention have been disclosed and described in detail herein, it may be apparent to those skilled in the art that various changes in form and detail may be made therein without departing from the spirit and scope thereof.

1. A method for notifying communications device users of the presence of an emergency vehicle, said method comprising the steps of:
determining position and probably route of the emergency vehicle;
determining at least one probable zone that the emergency vehicle will pass through en route to an emergency;
determining which communications devices are within the at least one probable zone based upon location of the communications devices;
selecting which communications devices within the at least one probable zone should be contacted to notify of the presence of an emergency vehicle to produce a group of selected communications devices; and
transmitting a signal to the selected communications devices within the at least one probable zone to notify of the presence of an emergency vehicle.

2. The method of claim 1, where the communications devices comprise at least one cellular telephone device, and the step of transmitting a signal to the selected communications devices within the at least one probable zone to notify of the presence of an emergency vehicle comprises:
placing a cellular telephone call to the at least on cellular telephone device, such that the cellular telephone device generates a predetermined ring-tone indicating the presence of an emergency vehicle.

3. The method of claim 2, where the ring-tone mimics the siren of an emergency vehicle.

4. The method of claim 2, wherein the step of transmitting a signal to the selected communications devices within the at least one probable zone to notify of the presence of an emergency vehicle, further comprises the step of:
generating at least one of a voice or text message on the at least one cellular telephone device, providing the user further information on the location of the emergency vehicle.

5. The method of claim 1, where the step of determining which communications devices are within the at least one probable zone based upon location of the communications devices, further comprises the steps of:
determining a group of cellular telephone devices for a cellular tower having a cell area overlapping at least a portion of the at least one probable zone;
determining position of at least one of cellular telephone devices in the group of cellular telephone devices; and
comparing position of the at least one of the cellular telephone devices in the group of cellular telephone devices with the at least one probable zone to determine whether the at least one of the cellular telephone devices of the group of cellular telephone devices is within the probable zone.

6. The method of claim 4, wherein the step of selecting which communications devices within the at least one probable zone should be contacted to notify of the presence of an emergency vehicle to produce a group of selected communications devices further comprises the steps of:
comparing position of one the group of cellular telephone devices within the probable zone with geographic data to determine whether the one of the group of cellular telephone devices within the probable zone is located at street level; and
if the one of the group of cellular telephone devices within the probable zone is not at street level, excluding that one of the group of cellular telephone devices within the probable zone the group of selected communications devices.

7. The method of claim 4, wherein the step of selecting which communications devices within the at least one probable zone should be contacted to notify of the presence of an emergency vehicle to produce a group of selected communications devices further comprises the steps of:
comparing position of one the group of cellular telephone devices within the probable zone with historical position data of the one of the group of cellular telephone devices to determine whether the one of the group of cellular telephone devices within the probable zone has remained stationary for a predetermined amount of time; and
if the one of the group of cellular telephone devices within the probable zone has remained stationary for a predetermined amount of time, excluding that one of the group of cellular telephone devices within the probable zone the group of selected communications devices.

8. The method of claim 4, wherein the step of selecting which communications devices within the at least one probable zone should be contacted to notify of the presence of an emergency vehicle to produce a group of selected communications devices further comprises the steps of:
comparing position of one the group of cellular telephone devices within the probable zone with geographic data to determine whether the one of the group of cellular telephone devices within a predetermined distance from a roadway; and
if the one of the group of cellular telephone devices within the probable zone is not within a predetermined distance from a roadway, excluding that one of the group of cellular telephone devices within the probable zone the group of selected communications devices.

9. The method of claim 5, wherein the step of determining position of at least one of cellular telephone devices in the group of cellular telephone devices, further comprises the steps of:
measuring time of arrival of signals from the at least one cellular telephone devices in the group of cellular telephone devices at a plurality of receivers; and
determining position of at least one of cellular telephone devices in the group of cellular telephone devices based upon time difference of arrival of the signals from the at least one cellular telephone devices in the group of cellular telephone devices at a plurality of receivers.

10. The method of claim 5, wherein at least one of cellular telephone devices in the group of cellular telephone devices comprises a Global Positioning System (GPS) enabled cellular telephone device outputting a GPS position; and
wherein the step of determining position of at least one of cellular telephone devices in the group of cellular telephone devices, further comprises the steps of:
determining position of the GPS enabled of cellular telephone device from its outputted GPS position.

11. The method of claim 1, wherein the step of determining at least one probable zone that the emergency vehicle will pass through en route to an emergency, comprises the step of:
determining position and direction of travel of the emergency vehicle;
determining position of a destination for the emergency vehicle;
determining whether the emergency vehicle is approaching an intersection;
generating a first zone representing possible paths the emergency vehicle may take in the direction of the destination for the emergency vehicle; and
generating a second zone representing possible paths the emergency vehicle may take in the direction of the destination of the emergency vehicle from the first zone.

12. A system for notifying communications device users of the presence of an emergency vehicle, said system comprising:
means for determining position and probably route of the emergency vehicle;
means for determining at least one probable zone that the emergency vehicle will pass through en route to an emergency;
means for determining which communications devices are within the at least one probable zone based upon location of the communications devices;
means for selecting which communications devices within the at least one probable zone should be contacted to notify of the presence of an emergency vehicle to produce a group of selected communications devices; and
means for transmitting a signal to the selected communications devices within the at least one probable zone to notify of the presence of an emergency vehicle.

13. The system of claim 12, where the communications devices comprise at least one cellular telephone device, and the means for transmitting a signal to the selected communications devices within the at least one probable zone to notify of the presence of an emergency vehicle comprises:
means for placing a cellular telephone call to the at least on cellular telephone device, such that the cellular telephone device generates a predetermined ring-tone indicating the presence of an emergency vehicle.

14. The system of claim 13, where the ring-tone mimics the siren of an emergency vehicle.

15. The system of claim 13, wherein the means for transmitting a signal to the selected communications devices within the at least one probable zone to notify of the presence of an emergency vehicle, further comprises the means for:
means for generating at least one of a voice or text message on the at least one cellular telephone device, providing the user further information on the location of the emergency vehicle.

16. The system of claim 12, where the means for determining which communications devices are within the at least one probable zone based upon location of the communications devices, further comprises:
means for determining a group of cellular telephone devices for a cellular tower having a cell area overlapping at least a portion of the at least one probable zone;
means for determining position of at least one of cellular telephone devices in the group of cellular telephone devices; and
means for comparing position of the at least one of the cellular telephone devices in the group of cellular telephone devices with the at least one probable zone to determine whether the at least one of the cellular telephone devices of the group of cellular telephone devices is within the probable zone.

17. The system of claim 15, wherein the means for selecting which communications devices within the at least one probable zone should be contacted to notify of the presence of an emergency vehicle to produce a group of selected communications devices further comprises:
means for comparing position of one the group of cellular telephone devices within the probable zone with geographic data to determine whether the one of the group of cellular telephone devices within the probable zone is located at street level and for excluding that one of the group of cellular telephone devices within the probable zone the group of selected communications devices if the one of the group of cellular telephone devices within the probable zone is not at street level.

18. The system of claim 15, wherein the means for selecting which communications devices within the at least one probable zone should be contacted to notify of the presence of an emergency vehicle to produce a group of selected communications devices further comprises:
means for comparing position of one the group of cellular telephone devices within the probable zone with historical position data of the one of the group of cellular telephone devices to determine whether the one of the group of cellular telephone devices within the probable zone has remained stationary for a predetermined amount of time; and excluding that one of the group of cellular telephone devices within the probable zone the group of selected communications devices if the one of the group of cellular telephone devices within the probable zone has remained stationary for a predetermined amount of time.

19. The system of claim 15, wherein the means for selecting which communications devices within the at least one probable zone should be contacted to notify of the presence of an emergency vehicle to produce a group of selected communications devices further comprises:
means for comparing position of one the group of cellular telephone devices within the probable zone with geographic data to determine whether the one of the group of cellular telephone devices within a predetermined distance from a roadway and excluding that one of the group of cellular telephone devices within the probable zone the group of selected communications devices if the one of the group of cellular telephone devices within the probable zone is not within a predetermined distance from a roadway.

20. The system of claim 16, wherein the means for determining position of at least one of cellular telephone devices in the group of cellular telephone devices, further comprises:
means measuring time of arrival of signals from the at least one cellular telephone devices in the group of cellular telephone devices at a plurality of receivers; and
means for determining position of at least one of cellular telephone devices in the group of cellular telephone devices based upon time difference of arrival of the signals from the at least one cellular telephone devices in the group of cellular telephone devices at a plurality of receivers.

21. The system of claim 16, wherein at least one of cellular telephone devices in the group of cellular telephone devices comprises a Global Positioning System (GPS) enabled cellular telephone device outputting a GPS position; and
wherein the means for determining position of at least one of cellular telephone devices in the group of cellular telephone devices, further comprises:
means for determining position of the GPS enabled of cellular telephone device from its outputted GPS position.

22. The system of claim 12, wherein the means for determining at least one probable zone that the emergency vehicle will pass through en route to an emergency, comprises the means for:
means for determining position and direction of travel of the emergency vehicle;
means for determining position of a destination for the emergency vehicle;
means for determining whether the emergency vehicle is approaching an intersection;
means for generating a first zone representing possible paths the emergency vehicle may take in the direction of the destination for the emergency vehicle; and
means for generating a second zone representing possible paths the emergency vehicle may take in the direction of the destination of the emergency vehicle from the first zone.
